(19) United States
(12) Patent Application Publication
(10) Pub. No.: US 2022/0318155 A1
(43) Pub. Date: Oct. 6, 2022

(54) INFORMATION PROCESSING APPARATUS AND INFORMATION PROCESSING METHOD

(71) Applicant: FUJITSU LIMITED, Kawasaki-shi (JP)

(72) Inventors: Shiho Nakahara, Nerima (JP); Takahide Yoshikawa, Kawasaki (JP)

(73) Assignee: FUJITSU LIMITED, Kawasaki-shi (JP)

(21) Appl. No.: 17/539,238

(22) Filed: Dec. 1, 2021

(30) Foreign Application Priority Data
Mar. 31, 2021 (JP) 2021-060316

(51) Int. Cl. G06F 12/10; G06F 12/0897

(52) U.S. Cl. CPC G06F 12/10; G06F 12/0897; G06F 2212/657

(57) ABSTRACT

An information processing apparatus includes: an arithmetic processing unit that includes: a processor that executes a program; and a cache memory coupled to the processor, wherein the cache memory includes: an acquisition unit that acquires a physical address of target information that is a target of an event that has occurred in the cache memory when the program is executed; and a generation unit that converts the physical address of the target information into a virtual address of the target information by using correspondence information that indicates correspondence between the physical address of the target information and the virtual address of the target information, and generates log information in which virtual address information that indicates the virtual address of the target information and identification information of the event are associated with each other.

### CROSS-REFERENCE TO RELATED APPLICATION

This application is based upon and claims the benefit of priority of the prior Japanese Patent Application No. 2021-60316, filed on Mar. 31, 2021, the entire contents of which are incorporated herein by reference.

### FIELD

The embodiment discussed herein is related to information processing.

### BACKGROUND

In recent information processing apparatuses (computers), a cache memory is often provided together with a central processing unit (CPU) in an arithmetic processing unit. Information stored in the cache memory is an instruction executed by the CPU or data used to execute the instruction.

When information used for instruction processing of the CPU exists in the cache memory and reading of the information from the cache memory succeeds, it is called a cache hit. On the other hand, when the information used for the instruction processing does not exist in the cache memory and reading of the information from the cache memory fails, it is called a cache miss.

In relation to the cache miss, there is known a compiler device for a computer system that may improve a hit rate of a cache memory. There is also known a CPU memory access analysis device that outputs a CPU memory access state with a low bandwidth without affecting behavior of a system in order to optimize a processing speed of software by CPU memory access analysis.

Examples of the related art include as follows: Japanese Laid-open Patent Publication No. 2009-277243; and Japanese Laid-open Patent Publication No. 2006-285430.

### SUMMARY

According to an aspect of the embodiments, there is provided an information processing apparatus including: an arithmetic processing unit that includes: a processor that executes a program; and a cache memory coupled to the processor. In an example, the cache memory includes: an acquisition unit that acquires a physical address of target information that is a target of an event that has occurred in the cache memory when the program is executed; and a generation unit that converts the physical address of the target information into a virtual address of the target information by using correspondence information that indicates correspondence between the physical address of the target information and the virtual address of the target information, and generates log information in which virtual address information that indicates the virtual address of the target information and identification information of the event are associated with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an information processing apparatus;

FIG. 2 is a flowchart of log generation processing;

FIG. 3 is a first hardware configuration diagram of the information processing apparatus;

FIG. 4 is a hardware configuration diagram of an L2 cache;

FIG. 5 is a diagram illustrating a conversion table;

FIG. 6 is a diagram illustrating a virtual address and a physical address;

FIG. 7 is a diagram illustrating log information;

FIG. 8 is a hardware configuration diagram of a table control unit;

FIG. 9 is a diagram illustrating update information;

FIG. 10 is a hardware configuration diagram of a log control unit;

FIG. 11 is a diagram illustrating an operation of the information processing apparatus in a cache monitor mode;

FIG. 12 is a diagram illustrating an operation of the information processing apparatus in a log acquisition mode;

FIG. 13 is a diagram illustrating the log generation processing;

FIG. 14 is a diagram illustrating analysis processing;

FIG. 15 is a diagram illustrating a virtual address table;

FIG. 16 is a flowchart of table generation processing;

FIG. 17 is a diagram illustrating log information acquired in processing in the log acquisition mode;

FIG. 18 is a flowchart of log information analysis processing;

FIG. 19 is a diagram illustrating the virtual address table to which columns are added; and

FIG. 20 is a second hardware configuration diagram of the information processing apparatus.

### DESCRIPTION OF EMBODIMENTS

A cache miss may occur in a case where prefetch of data to be accessed fails due to an unexpected result at the time of prefetching the data in a cache memory. In this case, a cause of the cache miss is a prefetch failure for specific data. Furthermore, a cache miss may occur also in a case where data is expelled from a cache memory. In this case, a cause of the cache miss is expulsion of specific data.

In tuning or debugging a program executed by an information processing apparatus, statistical information regarding cache misses and a physical address (PA) of data in which a cache miss has occurred may be acquired. However, a virtual address (VA) of the data in which the cache miss has occurred is unknown.

On the other hand, since software recognizes only a virtual address space and does not recognize a physical address space, it is difficult to specify a cause of the cache miss without knowing the virtual address of the data. In a case where the cause of the cache miss is not specified, it will be difficult to modify the program to reduce the cache miss.

When a virtual address is added to a read request and a write request transmitted and received by the cache memory in order to acquire the virtual address of the data in which the cache miss has occurred, an amount of use of a memory band increases. When wiring between the cache memory and a main storage device is increased in order to avoid the increase in the amount of use of the memory band, a wiring area increases.

Note that such a problem occurs not only in a case where a cache miss for data occurs but also in a case where a cache miss for an instruction occurs. Furthermore, such a problem occurs not only in the case of a cache miss but also in the case of analyzing various operations of the cache memory.

In one aspect, an embodiment aims to record an operation of a cache memory in association with a virtual address of information.

Hereinafter, an embodiment will be described in detail with reference to the drawings.

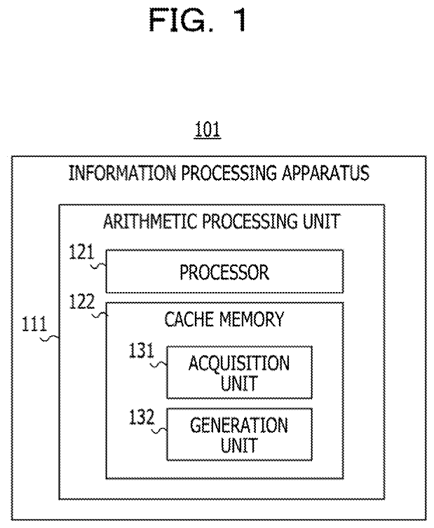

FIG. 1 illustrates a configuration example of an information processing apparatus of an embodiment. An information processing apparatus 101 of FIG. 1 includes an arithmetic processing unit 111. The arithmetic processing unit 111 includes a processor 121 and a cache memory 122, and the cache memory 122 includes an acquisition unit 131 and a generation unit 132.

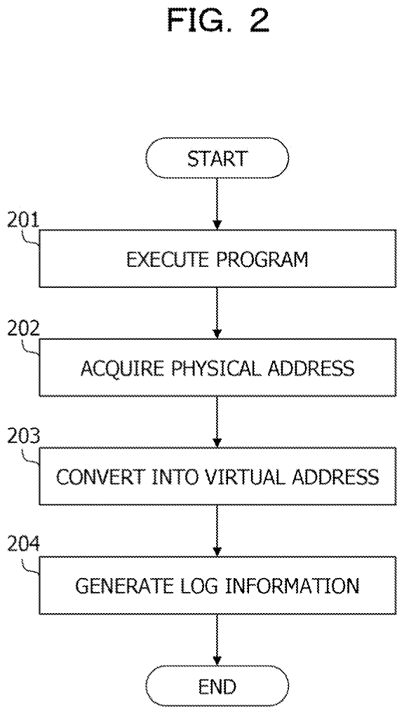

FIG. 2 is a flowchart illustrating an example of log generation processing performed by the information processing apparatus 101 of FIG. 1. First, the processor 121 executes a program (Step 201), and the acquisition unit 131 acquires, when the program is executed, a physical address of target information that is a target of an event occurred in the cache memory (Step 202).

Next, the generation unit 132 converts the physical address of the target information into a virtual address of the target information by using correspondence information indicating correspondence between the physical address of the target information and the virtual address of the target information (Step 203). Then, the generation unit 132 generates log information in which virtual address information indicating the virtual address of the target information and identification information of the event are associated with each other (Step 204).

According to the information processing apparatus 101 of FIG. 1, it is possible to record an operation of the cache memory 122 in association with a virtual address of information.

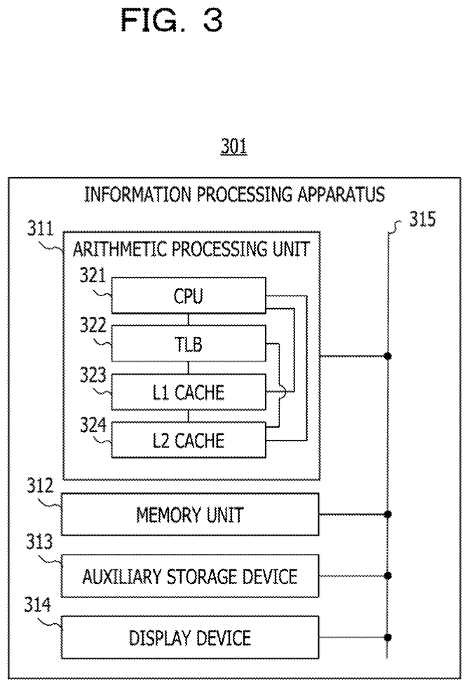

FIG. 3 is a first hardware configuration diagram of the information processing apparatus 101 of FIG. 1. An information processing apparatus 301 of FIG.

3 includes an arithmetic processing unit 311, a memory unit 312, an auxiliary storage device 313, and a display device 314. These components are hardware, and are connected to each other by a bus 315.

The arithmetic processing unit 311 includes a central processing unit (CPU) 321, a translation lookaside buffer (TLB) 322, a Level 1 (L1) cache 323, and a Level 2 (L2) cache 324. These components are hardware.

The TLB 322 holds correspondence information indicating correspondence between a physical address and a virtual address of each of a plurality of pieces of data. In a case where the TLB 322 receives a virtual address from the CPU 321, the TLB 322 converts the received virtual address into a corresponding physical address by using the correspondence information, and transmits the physical address to the L1 cache 323. The TLB 322 is an example of a conversion unit.

The L1 cache 323 is a primary cache memory, and the L2 cache 324 is a secondary cache memory. The L2 cache 324 belongs to a storage hierarchy lower than the L1 cache 323. Thus, the L2 cache 324 has a slower access speed than the L1 cache 323, and has a larger storage capacity than the L1 cache 323.

The arithmetic processing unit 311 corresponds to the arithmetic processing unit 111 of FIG. 1. The CPU 321 and the L2 cache 324 correspond to the processor 121 and the cache memory 122 of FIG. 1, respectively.

The memory unit 312 is a semiconductor memory such as a random access memory (RAM), and stores an analysis target program and data. The memory unit 312 is sometimes called a main memory device. The CPU 321 executes the analysis target program by using the data stored in the memory unit 312.

The auxiliary storage device 313 is, for example, a magnetic disk device, an optical disk device, a magneto-optical disk device, or a tape device. The auxiliary storage device 313 may be a hard disk drive. The information processing apparatus 301 may store the analysis target program and data in the auxiliary storage device 313, and load them into the memory unit 312 to use. The display device 314 displays an inquiry or instruction to a user and a processing result on a screen.

The following events may occur in the arithmetic processing unit 311 when the analysis target program is executed.

Fetch (L2→L1)

Fetch (Main→L2)

Prefetch (L2→L1)

Prefetch (Main→L2)

Replacement

Invalidation

Write (L1→L2)

Write (L2→Main)

The fetch (L2→L1) represents an operation in which the L2 cache 324 transmits data to the L1 cache 323 and the L1 cache 323 receives the data from the L2 cache 324. The fetch (main→L2) represents an operation in which the memory unit 312 transmits data to the L2 cache 324 and the L2 cache 324 receives the data from the memory unit 312.

The prefetch (L2→L1) represents an operation in which the L1 cache 323 prefetches data from the L2 cache 324, and the prefetch (main→L2) represents an operation in which the L2 cache 324 prefetches data from the memory unit 312. The fetch (L2→L1), the fetch (main→L2), the prefetch (L2→L1), and the prefetch (main→L2) correspond to data read.

The replacement represents an operation of deleting data by replacing a cache line, and the invalidation represents an operation of invalidating a cache line. The replacement and the invalidation correspond to data deletion.

The write (L1→L2) represents an operation in which the L1 cache 323 transmits data to the L2 cache 324 and the L2 cache 324 receives the data from the L1 cache 323. The write (L2→main) represents an operation in which the L2 cache 324 transmits data to the memory unit 312 and the memory unit 312 receives the data from the L2 cache 324. The write (L1→L2) and the write (L2→main) correspond to data write.

A packet is transmitted and received between the L1 cache 323 and the L2 cache 324, or between the L2 cache 324 and the memory unit 312, depending on an event that has occurred. The packet to be transmitted and received includes, for example, event information indicating an event that has occurred, target data that is a target of the event, and a physical address of the target data.

The CPU 321 transmits an access request to the TLB 322 when accessing data stored in the memory unit 312 at the time of execution of the analysis target program. The access request is, for example, a read request or a write request, and includes a virtual address of data to be accessed. The TLB 322 converts the virtual address included in the access request into a corresponding physical address, and transmits the physical address to the L1 cache 323.

In a case where the access request is a read request and a cache hit occurs in the L1 cache 323, the L1 cache 323 transmits requested data to the CPU 321. On the other hand, in a case where a cache miss occurs in the L1 cache 323, the L1 cache 323 transmits a packet including a physical address of requested data to the L2 cache 324.

In a case where a cache hit occurs in the L2 cache 324, the L2 cache 324 transmits a fetch (L2→L1) packet to the L1 cache 323. The fetch (L2→L1) packet includes event information indicating the fetch (L2→L1), data to be a target of the fetch (L2→L1), and a physical address of the data. The data to be a target of the fetch (L2→L1) is data in which a cache hit occurs.

The L1 cache 323 stores data included in the received fetch (L2→L1) packet, and transmits the data to the CPU 321.

On the other hand, in a case where a cache miss occurs in the L2 cache 324, the L2 cache 324 transmits a packet including a physical address of requested data to the memory unit 312.

The memory unit 312 extracts the data stored in the physical address included in the received packet, and transmits a fetch (main→L2) packet to the L2 cache 324. The fetch (main→L2) packet includes event information indicating the fetch (main→L2), data to be a target of the fetch (main→L2), and a physical address of the data. The data to be a target of the fetch (main→L2) is data extracted from the memory unit 312.

The L2 cache 324 stores data included in the received packet, and transmits the fetch (L2→L1) packet to the L1 cache 323. The fetch (L2→L1) packet includes event information indicating the fetch (L2→L1), data to be a target of the fetch (L2→L1), and a physical address of the data. The data to be a target of the fetch (L2→L1) is data included in the packet received from the memory unit 312.

The L1 cache 323 stores data included in the received fetch (L2→L1) packet, and transmits the data to the CPU 321.

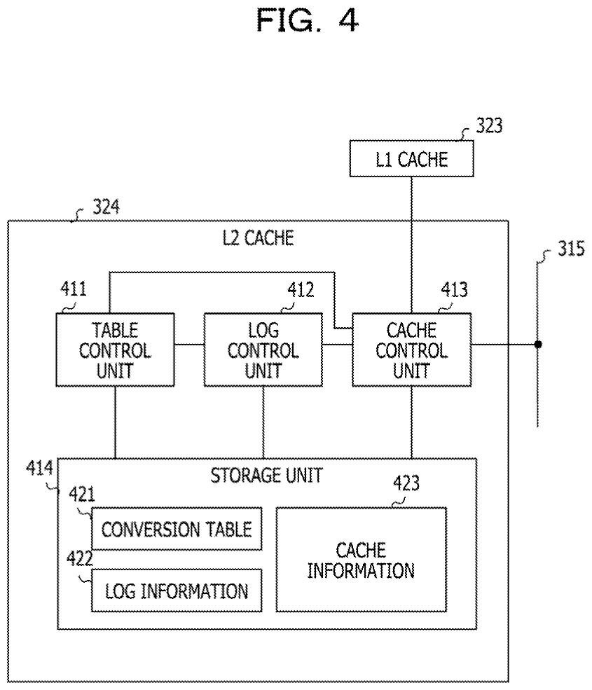

FIG. 4 illustrates a hardware configuration example of the L2 cache 324 of FIG. 3. The L2 cache 324 of FIG. 4 includes a table control unit 411, a log control unit 412, a cache control unit 413, and a storage unit 414. These components are hardware circuits. The storage unit 414 may be a memory array. The cache control unit 413 corresponds to the acquisition unit 131 of FIG. 1.

The storage unit 414 stores a conversion table 421 and cache information 423. The conversion table 421 includes the same correspondence information as the correspondence information held by the TLB 322.

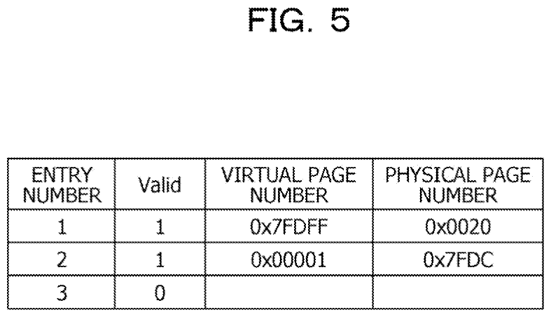

FIG. 5 illustrates an example of the conversion table 421 of FIG. 4. Each entry of the conversion table 421 of FIG. 5 includes an entry number, Valid, a virtual page number, and a physical page number. The correspondence information held by the TLB 322 also includes entries similar to those of FIG. 5.

The entry number is identification information of an entry, and the Valid indicates whether the entry is valid or invalid. In a case where the Valid is logic “1”, the entry is valid, and in a case where the Valid is logic “0”, the entry is invalid.

The virtual page number is a page number included in a virtual address, and the physical page number is a page number included in a physical address. In this example, the virtual page number and the physical page number are indicated in hexadecimal numbers. The physical page number in each entry corresponds to the virtual page number of the same entry. Thus, the conversion table 421 indicates correspondence between the physical address and the virtual address of each piece of data.

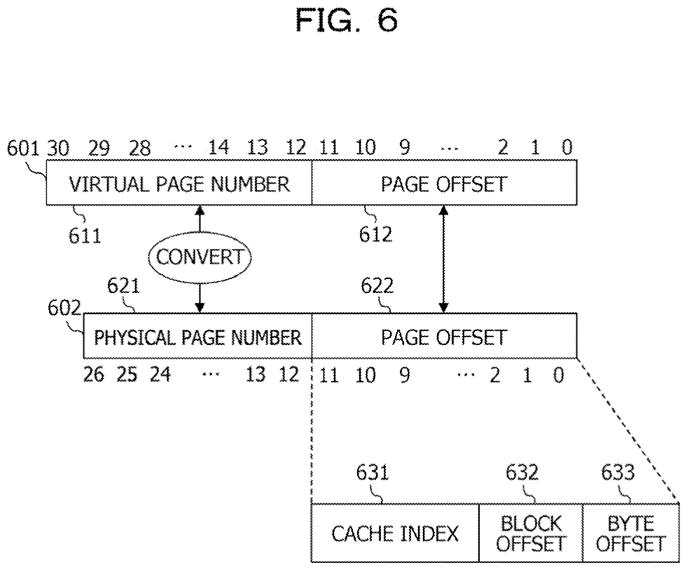

FIG. 6 illustrates an example of a virtual address and a physical address. The size of a virtual memory space is 2 GB, and the size of a physical memory space is 128 MB. The virtual memory space and the physical memory space are divided into pages of 4 KB.

A virtual address 601 of FIG. 6 represents a 31-bit address in the virtual memory space, and includes a 19-bit virtual page number 611 and a 12-bit page offset 612. A physical address 602 corresponds to the virtual address 601, and represents a 27-bit address in the physical memory space. The physical address 602 includes a 15-bit physical page number 621 and a 12-bit page offset 622.

Contents of the page offset 622 are the same as contents of the page offset 612, and include a cache index 631, a block offset 632, and a byte offset 633.

The cache index 631 is information indicating a cache line, the block offset 632 is information indicating a position of a word in the cache line, and the byte offset 633 is information indicating a position of a byte in the word.

Since the contents of the page offset 612 and the page offset 622 are the same, it becomes possible to perform conversion between the virtual address and the physical address only by recording the virtual page number 611 and the physical page number 621 in association with each other in the conversion table 421.

The cache information 423 includes a plurality of cache lines, and each cache line includes data received by the L2 cache 324 from the L1 cache 323 or the memory unit 312. The data included in each cache line corresponds to a page or a block.

The cache control unit 413 is connected to the L1 cache 323, and may transmit and receive a packet to and from the L1 cache 323. The cache control unit 413 is also connected to the bus 315, and may transmit and receive a packet to and from the memory unit 312.

In a case where a packet including a physical address of data is received from the L1 cache 323 and a cache hit occurs, the cache control unit 413 extracts data corresponding to the physical address included in the received packet from the cache information 423. Then, the cache control unit 413 transmits a fetch (L2→L1) packet including the extracted data to the L1 cache 323 and the log control unit 412.

On the other hand, in a case where a cache miss occurs, the cache control unit 413 transmits a packet including a physical address of requested data to the memory unit 312, and receives a fetch (main→L2) packet from the memory unit 312.

Next, the cache control unit 413 records data included in the fetch (main→L2) packet in the cache information 423, and transmits the packet to the log control unit 412. Then, the cache control unit 413 transmits a fetch (L2→L1) packet including the data recorded in the cache information 423 to the L1 cache 323 and the log control unit 412.

The table control unit 411 refers to or updates the conversion table 421 in response to a request from the log control unit 412 or the cache control unit 413.

The log control unit 412 requests the table control unit 411 to convert the physical address included in the packet received from the cache control unit 413. The table control unit 411 converts the physical address into a virtual address by using the conversion table 421, and outputs the virtual address to the log control unit 412. At this time, the table control unit 411 uses the conversion table 421 to convert a physical page number included in the physical address into a virtual page number, and connects the virtual page number with a page offset included in the physical address to generate the virtual address.

The log control unit 412 generates virtual address information including the virtual page number and a cache index by removing a block offset and a byte offset from the virtual address output from the table control unit 411. Then, the log control unit 412 generates an entry of log information 422 by using the virtual address information, and stores the entry in the storage unit 414.

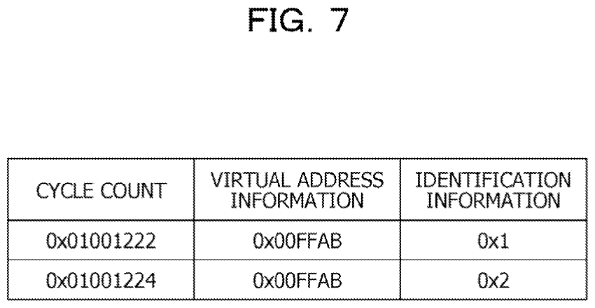

FIG. 7 illustrates an example of the log information 422 of FIG. 4. Each entry of the log information 422 of FIG. 7 includes a cycle count, virtual address information, and identification information. The cycle count is information indicating time when an event occurs, and the virtual address information includes a virtual page number and a cache index. In this example, the cycle count and the virtual address information are indicated in hexadecimal numbers. The identification information is identification information of an event corresponding to event information included in a received packet.

When a virtual page number and the cache index are known, a cache line in which data indicated by a virtual address is stored may be specified. Thus, a block offset and a byte offset are excluded from the virtual address information. As the identification information, for example, the following values may be used.

0x1 fetch (L2→L1)

0x2 fetch (main→L2)

0x3 prefetch (L2→L1)

0x4 prefetch (main→L2)

0x5 replacement

0x6 invalidation

0x7 write (L1→L2)

0x8 write (L2→main)

Note that, another information may be added to the entries of the log information 422. The another information is physical address information corresponding to the virtual address information, data to be a target of an event, a value of a program counter when an event occurs, or the like. In a case where the physical address information is added, the log control unit 412 generates the physical address information by removing a block offset and a byte offset from a physical address included in a packet received from the cache control unit 413. The physical address information includes a physical page number and a cache index.

The information processing apparatus 301 operates in any one of operation modes including a normal mode, a cache monitor mode, and a log acquisition mode. In the cache monitor mode, the information processing apparatus 301 monitors input/output of data in the L2 cache 324, and generates an entry of the log information 422 when an event occurs.

In the log acquisition mode, the information processing apparatus 301 acquires the log information 422 from the storage unit 414. In the normal mode, the information processing apparatus 301 performs information processing without generating or acquiring the log information 422.

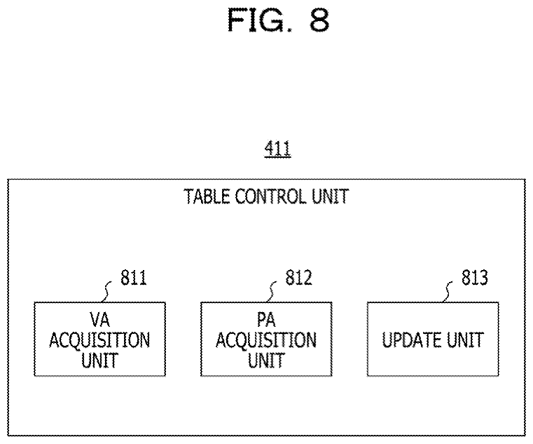

FIG. 8 illustrates a hardware configuration example of the table control unit 411 of FIG. 4. The table control unit 411 of FIG. 8 includes a virtual address (VA) acquisition unit 811, a physical address (PA) acquisition unit 812, and an update unit 813. These components are hardware circuits.

In a case where a physical address is input from the log control unit 412, the VA acquisition unit 811 refers to an entry including a physical page number in the input physical address in the conversion table 421. Then, the VA acquisition unit 811 acquires a virtual page number from the entry, generates a virtual address including the acquired virtual page number, and outputs the virtual address to the log control unit 412.

In a case where a virtual page number is input from an external request source, the PA acquisition unit 812 refers to an entry including the input virtual page number in the conversion table 421. Then, the PA acquisition unit 812 acquires a physical page number from the entry, and outputs the acquired physical page number to the request source. The external request source may be a hardware circuit not illustrated in FIGS. 3 and 4.

In a case where the update unit 813 receives update information indicating update of correspondence information in the TLB 322, the update unit 813 updates the conversion table 421 on the basis of the received update information, so that the update in the TLB 322 is reflected in the conversion table 421. With this configuration, the conversion table 421 may be synchronized with the correspondence information in the TLB 322.

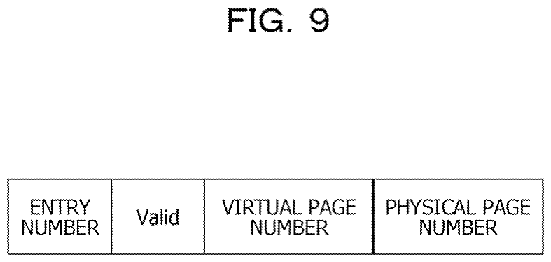

FIG. 9 illustrates an example of the update information. The update information of FIG. 9 is a packet, and includes an entry number, Valid, virtual page number, and physical page number of an updated entry among entries of the correspondence information held by the TLB 322.

The TLB 322 transmits the packet of FIG. 9 to the L2 cache 324, and the cache control unit 413 transmits the received packet to the table control unit 411. The update unit 813 updates the conversion table 421 by overwriting information included in the packet on an entry having the same entry number in the conversion table 421.

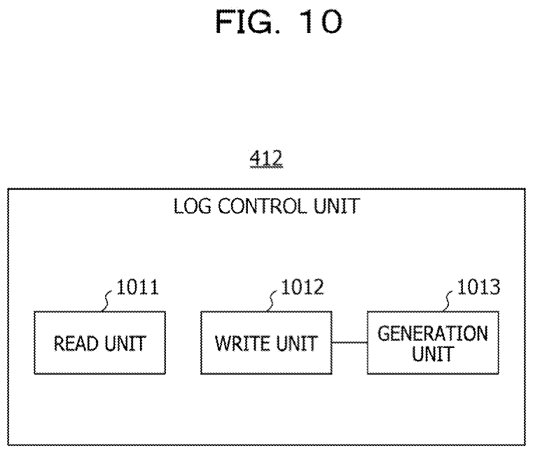

FIG. 10 illustrates a hardware configuration example of the log control unit 412 of FIG. 4. The log control unit 412 of FIG. 10 includes a read unit 1011, a write unit 1012, and a generation unit 1013. These components are hardware circuits. The VA acquisition unit 811 of FIG. 8 and the generation unit 1013 of FIG. 10 correspond to the generation unit 132 of FIG. 1.

In a case where the generation unit 1013 receives a validation signal from the CPU 321, the generation unit 1013 validates the cache monitor mode, and in a case where the generation unit 1013 receives an invalidation signal from the CPU 321, the generation unit 1013 invalidates the cache monitor mode.

In a case where the cache monitor mode is validated, the generation unit 1013 requests the table control unit 411 to convert a physical address included in a packet received from the cache control unit 413. Then, the generation unit 1013 receives a virtual address corresponding to the physical address from the table control unit 411.

Next, the generation unit 1013 generates virtual address information by removing a block offset and a byte offset from the virtual address output from the table control unit 411, and generates an entry of the log information 422 by using the generated virtual address information. Then, the generation unit 1013 transmits the generated entry to the write unit 1012. The write unit 1012 writes the entry received from the generation unit 1013 to the log information 422.

In a case where the read unit 1011 receives a log request from the CPU 321, the read unit 1011 reads the log information 422 from the storage unit 414, and transmits the log information 422 to the CPU 321.

According to the information processing apparatus 301 of FIG. 3, in a case where an event occurs in the L2 cache 324, identification information of the event is recorded in the log information 422 in association with a virtual address of data to be a target of the event. With this configuration, it is possible to record an operation of the L2 cache 324 in association with a virtual address of data.

A variable in the analysis target program may be specified from a virtual address included in the log information 422, and an operation such as read, write, or delete, and a data transmission destination or data transmission source may be specified from identification information of an event.

For example, it is assumed that fetch (L2→L1) occurs due to a cache miss occurring in the L1 cache 323. In this case, a variable that caused the cache miss in the L1 cache 323 may be specified by referring to an entry of the fetch (L2→L1) in the log information 422.

Furthermore, it is assumed that fetch (main→L2) occurs due to a cache miss occurring in the L2 cache 324. In this case, a variable that caused the cache miss in the L2 cache 324 may be specified by referring to an entry of the fetch (main→L2) in the log information 422.

Note that, in the information processing apparatus 301, one or more different cache memories may be provided between the L2 cache 324 and the memory unit 312. In this case, when a cache miss occurs in a cache memory M belonging to a memory hierarchy closest to the memory unit 312, fetch from the memory unit 312 to the cache memory M is performed.

Then, instead of identification information indicating the fetch (main→L2), identification information indicating the fetch from the memory unit 312 to the cache memory M is recorded in an entry of the log information 422. By referring to the recorded entry, a variable that caused the cache miss in the cache memory M may be specified.

Furthermore, the information processing apparatus 301 may not be provided with the L2 cache 324. In this case, when a cache miss occurs in the L1 cache 323, fetch from the memory unit 312 to the L1 cache 323 is performed.

Then, instead of the identification information indicating the fetch (main→L2), identification information indicating the fetch from the memory unit 312 to the L1 cache 323 is recorded in an entry of the log information 422. By referring to the recorded entry, a variable that caused the cache miss in the L1 cache 323 may be specified.

Examples of a method in which the information processing apparatus 301 accumulates the log information 422 include the following methods.

(M1) The write unit 1012 stores all the log information 422 in the storage unit 414.

(M2) The write unit 1012 stores the log information 422 in the storage unit 414, and periodically writes the log information 422 to the memory unit 312 or the auxiliary storage device 313.

(M3) The write unit 1012 stores the log information 422 in the memory unit 312 or the auxiliary storage device 313 instead of storing the log information 422 in the storage unit 414.

(M4) The write unit 1012 stores the log information 422 in the storage unit 414 in a wraparound manner. In this case, when a storage area for writing a new entry is insufficient in the storage unit 414, the write unit 1012 writes a new entry after deleting the oldest entry. According to this method, a writing control of the log information 422 becomes easy.

In the future, it is assumed that a capacity of the L2 cache 324 will increase due to three-dimensional integration or the like. In this case, by adopting the method (M1) and using the increased capacity for accumulating the log information 422, writing to the memory unit 312 or the auxiliary storage device 313 may be omitted, and the analysis target program may be executed at high speed. Furthermore, since the log information 422 may be stored only by sequential access of the storage unit 414, a scale of a control circuit may be reduced.

The write unit 1012 may accumulate the log information 422 by using any one of the methods (M1) to (M3) and the method (M4) in combination.

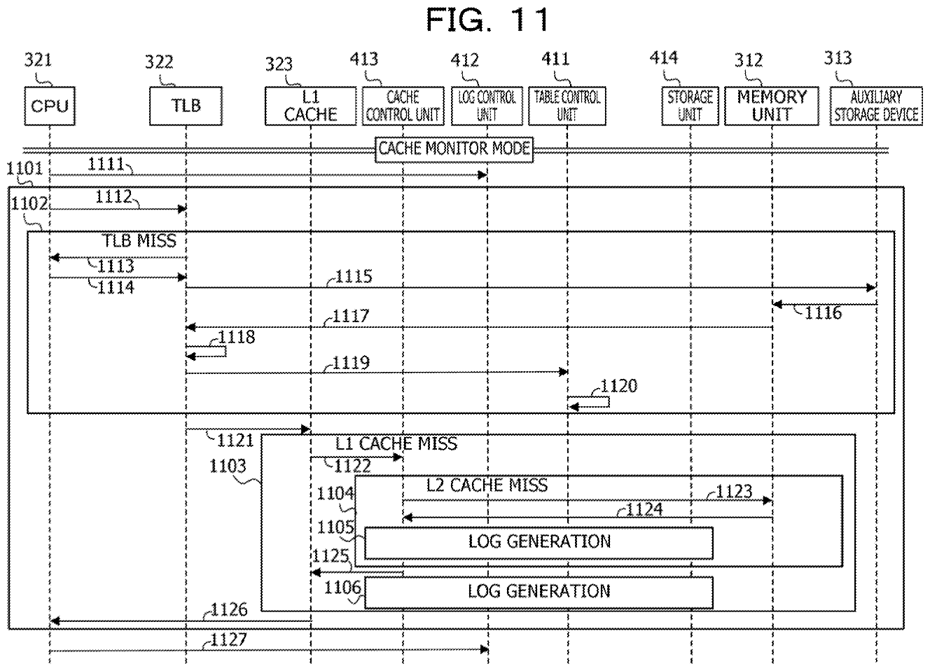

FIG. 11 illustrates an example of an operation of the information processing apparatus 301 in the cache monitor mode. First, the CPU 321 transmits a validation signal that validates the cache monitor mode to the L2 cache 324, and the generation unit 1013 in the log control unit 412 validates the cache monitor mode on the basis of the received validation signal (procedure 1111).

The next processing 1101 is repeated every time the CPU 321 refers to data in a state where the cache monitor mode is validated. In the processing 1101, the CPU 321 transmits a read request including a virtual address of data to the TLB 322 (procedure 1112).

The next processing 1102 is performed in a case where a TLB miss occurs in the TLB 322, and is skipped in a case where a TLB hit occurs. In the processing 1102, the TLB 322 notifies the CPU 321 of a page fault (procedure 1113), and the CPU 321 instructs the TLB 322 to update the TLB 322 (procedure 1114).

Next, the TLB 322 transmits a page request indicating a page in which the TLB miss occurs to the auxiliary storage device 313 (procedure 1115), and the auxiliary storage device 313 transmits a page indicated by the page request to the memory unit 312 (procedure 1116). The memory unit 312 stores the received page, and transmits a load completion notification including a physical page number of the page to the TLB 322 (procedure 1117). At this time, a page table is updated due to swap-out and swap-in of data.

Next, the TLB 322 updates correspondence information by recording a virtual page number in which the TLB miss occurs and the physical page number included in the load completion notification in association with the held correspondence information (procedure 1118). Then, the TLB 322 transmits, as update information, a packet including a combination of the recorded virtual page number and physical page number to the L2 cache 324 (procedure 1119).

Next, the update unit 813 in the table control unit 411 updates the conversion table 421 by recording the combination of the virtual page number and the physical page number included in the received packet in the conversion table 421 (procedure 1120). Since page fault processing is software processing, time needed for updating may be hidden by updating the conversion table 421 by hardware processing.

Next, the TLB 322 converts the virtual address included in the read request received from the CPU 321 into a corresponding physical address, and transmits the physical address to the L1 cache 323 (procedure 1121).

The next processing 1103 is performed in a case where a cache miss occurs in the L1 cache 323, and is skipped in a case where a cache hit occurs. In the processing 1103, the L1 cache 323 transmits a packet including the physical address received from the TLB 322 to the L2 cache 324 (procedure 1122).

The next processing 1104 is performed in a case where a cache miss occurs in the L2 cache 324, and is skipped in a case where a cache hit occurs. In the processing 1104, the cache control unit 413 extracts the physical address from the received packet, and transmits the packet including the physical address to the memory unit 312 (procedure 1123).

Next, the memory unit 312 transmits a fetch (main→L2) packet including data indicated by the physical address included in the received packet to the L2 cache 324 (procedure 1124). The cache control unit 413 extracts the data from the received fetch (main→L2) packet, and records the data in the cache information 423. Then, the L2 cache 324 performs log generation processing 1105.

Next, the cache control unit 413 reads, from the cache information 423, the data indicated by the physical address included in the packet received from the L1 cache 323. Then, the cache control unit 413 transmits a fetch (L2→L1) packet including the read data to the L1 cache 323 (procedure 1125).

The L1 cache 323 stores the data included in the received fetch (L2→L1) packet. Then, the L2 cache 324 performs log generation processing 1106.

Next, the L1 cache 323 transmits the data indicated by the physical address received from the TLB 322 to the CPU 321 (procedure 1126).

After the processing 1101 is repeated, the CPU 321 transmits an invalidation signal that invalidates the cache monitor mode to the L2 cache 324 (procedure 1127). Then, the generation unit 1013 in the log control unit 412 invalidates the cache monitor mode on the basis of the received invalidation signal.

The processing 1101 of FIG. 11 is processing in a case where a read request is transmitted from the CPU 321 to the TLB 322, but the CPU 321 may also transmit a write request to the TLB 322. Also in a case where a write request is transmitted, processing similar to the processing 1101 is performed except for the procedure 1126.

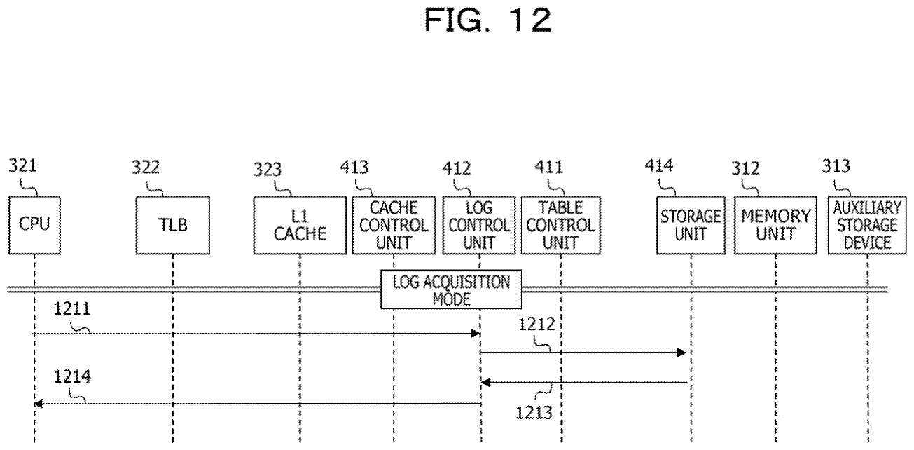

FIG. 12 illustrates an example of an operation of the information processing apparatus 301 in the log acquisition mode. First, the CPU 321 transmits a log request to the L2 cache 324, and the cache control unit 413 transmits the received log request to the log control unit 412 (procedure 1211).

On the basis of the received log request, the read unit 1011 in the log control unit 412 requests the log information 422 to the storage unit 414 (procedure 1212), and reads the log information 422 from the storage unit 414 (procedure 1213). Then, the read unit 1011 transmits the read log information 422 to the cache control unit 413, and the cache control unit 413 transmits the received log information 422 to the CPU 321 (procedure 1214).

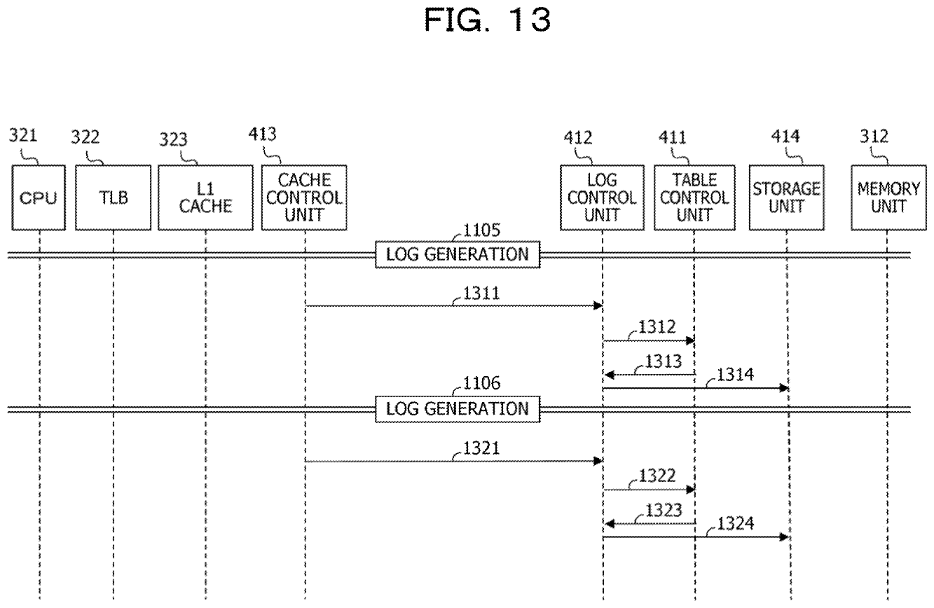

FIG. 13 illustrates examples of the log generation processing 1105 and the log generation processing 1106 of FIG. 11. In the log generation processing 1105, the cache control unit 413 transmits the fetch (main→L2) packet received from the memory unit 312 to the log control unit 412 (procedure 1311).

The generation unit 1013 in the log control unit 412 transmits the physical address included in the received fetch (main→L2) packet to the table control unit 411 (procedure 1312). Then, the generation unit 1013 receives a corresponding virtual address from the table control unit 411 (procedure 1313).

Next, the generation unit 1013 generates virtual address information from the virtual address received from the table control unit 411, and generates an entry of the log information 422 by using the generated virtual address information. Then, the generation unit 1013 transmits the generated entry to the write unit 1012. The write unit 1012 writes the entry received from the generation unit 1013 to the log information 422 in the storage unit 414 (procedure 1314).

In the log generation processing 1106, the cache control unit 413 transmits the fetch (L2→L1) packet transmitted to the L1 cache 323 to the log control unit 412 (procedure 1321).

The generation unit 1013 in the log control unit 412 transmits the physical address included in the received fetch (L2→L1) packet to the table control unit 411 (procedure 1322). Then, the generation unit 1013 receives a corresponding virtual address from the table control unit 411 (procedure 1323).

Next, the generation unit 1013 generates virtual address information from the virtual address received from the table control unit 411, and generates an entry of the log information 422 by using the generated virtual address information. Then, the generation unit 1013 transmits the generated entry to the write unit 1012. The write unit 1012 writes the entry received from the generation unit 1013 to the log information 422 in the storage unit 414 (procedure 1324).

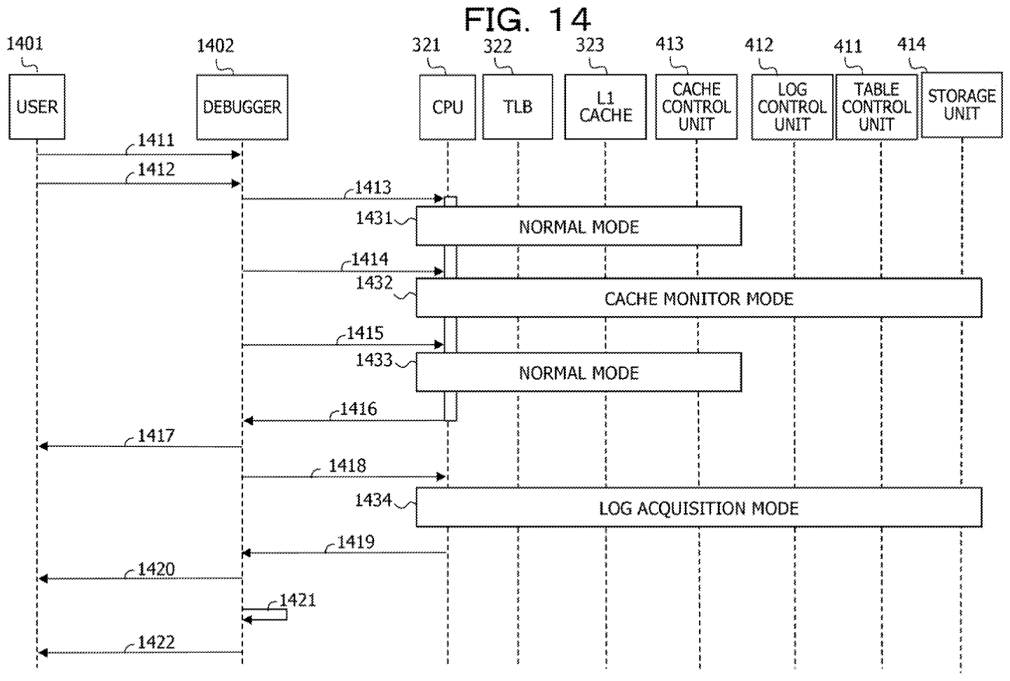

FIG. 14 illustrates an example of analysis processing using the information processing apparatus 301 of FIG. 3. A debugger 1402 is a program that supports a debug operation, and is executed by the CPU 321.

First, a user 1401 specifies a tuning target portion in the analysis target program in units such as functions, inputs the specified tuning target portion to the debugger 1402 (procedure 1411), and activates the debugger 1402 (procedure 1412).

The debugger 1402 requests the CPU 321 to execute the analysis target program (procedure 1413), and the information processing apparatus 301 performs processing 1431 in the normal mode.

The debugger 1402 requests the CPU 321 to validate the cache monitor mode at a start position of the tuning target portion (procedure 1414), and the CPU 321 transmits a validation signal to the L2 cache 324. Then, the information processing apparatus 301 performs processing 1432 in the cache monitor mode.

The debugger 1402 requests the CPU 321 to invalidate the cache monitor mode at an end position of the tuning target portion (procedure 1415), and the CPU 321 transmits an invalidation signal to the L2 cache 324. Then, the information processing apparatus 301 performs processing 1433 in the normal mode.

In a case where execution of the analysis target program ends (procedure 1416), the debugger 1402 notifies the user of the end of the execution (procedure 1417). Then, the debugger 1402 requests the CPU 321 to acquire the log information 422 (procedure 1418), and the information processing apparatus 301 performs processing 1434 in the log acquisition mode.

The CPU 321 transfers the log information 422 received from the L2 cache 324 to the debugger 1402 (procedure 1419), and the debugger 1402 displays the log information 422 on the screen of the display device 314 (procedure 1420). With this configuration, the user 1401 may confirm contents of the log information 422.

Next, the debugger 1402 analyzes the log information 422 (procedure 1421), and displays an analysis result on the screen of the display device 314 (procedure 1422). With this configuration, the user 1401 may confirm the analysis result.

In the analysis processing of FIG. 14, the CPU 321 generates a virtual address table by executing the debugger 1402. The virtual address table includes a virtual address of a variable included in the tuning target portion in the analysis target program, and is stored in the memory unit 312.

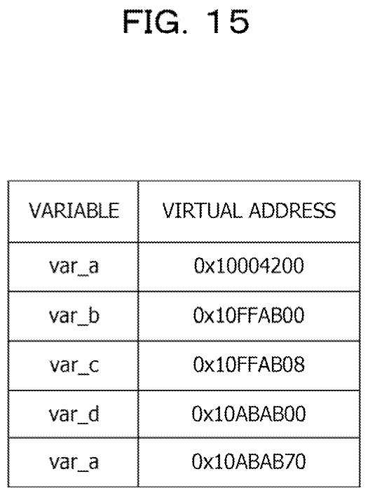

FIG. 15 illustrates an example of the virtual address table. Each entry of the virtual address table of FIG. 15 includes a variable and a virtual address of the variable. In this example, the virtual address is indicated in a hexadecimal number.

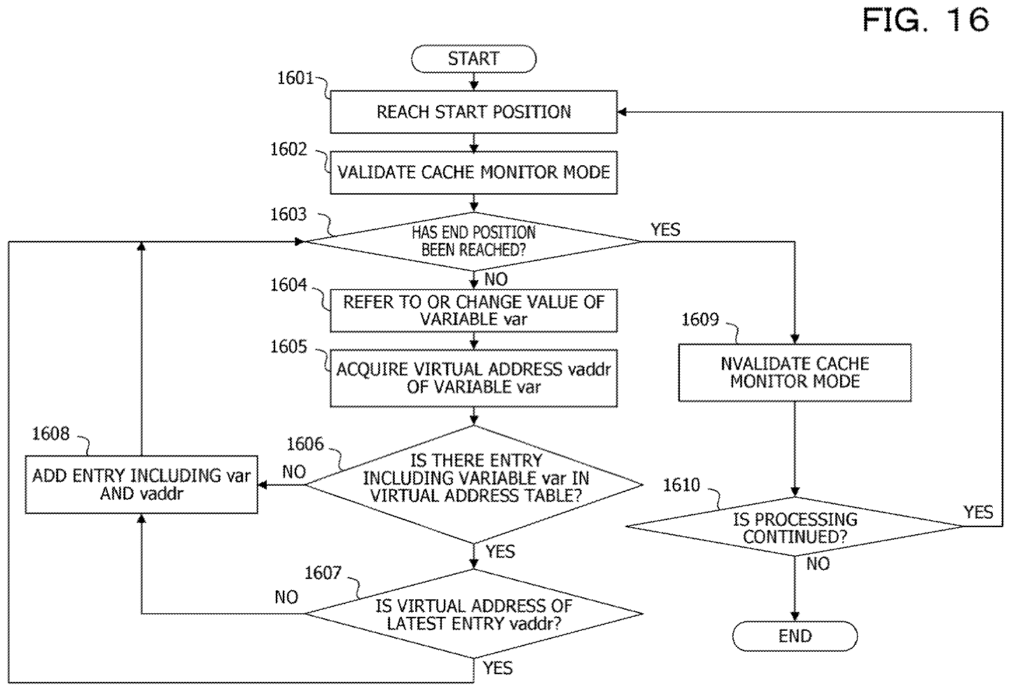

FIG. 16 is a flowchart illustrating an example of table generation processing for generating a virtual address table. The CPU 321 performs the generation processing of FIG. 16 by executing the debugger 1402.

First, the CPU 321 starts execution of the debugger 1402 and the analysis target program, and a position of an instruction to be executed in the analysis target program reaches the start position of the tuning target portion (Step 1601).

Next, the CPU 321 validates the cache monitor mode by transmitting a validation signal to the L2 cache 324 (Step 1602). Then, the CPU 321 checks whether or not the position of the instruction to be executed has reached the end position of the tuning target portion (Step 1603).

In a case where the position of the instruction to be executed has not reached the end position of the tuning target portion (NO in Step 1603), the CPU 321 refers to or changes a value of a variable included in the tuning target portion, and sets a variable name of the variable to var (Step 1604). Then, the CPU 321 acquires a virtual address of the variable set to var, and sets the virtual address to vaddr (Step 1605).

Next, the CPU 321 checks whether or not there is an entry including the variable var in the virtual address table (Step 1606). In a case where there is an entry including the variable var (YES in Step 1606), the CPU 321 checks whether or not a virtual address of the latest entry among entries including the variable var is vaddr (Step 1607). In a case where the virtual address of the latest entry is vaddr (YES in Step 1607), the CPU 321 repeats the processing of Step 1603 and subsequent steps.

On the other hand, in a case where the virtual address of the latest entry is not vaddr (NO in Step 1607), the CPU 321 adds an entry including the variable var and the virtual address vaddr to the virtual address table (Step 1608). Then, the CPU 321 repeats the processing of Step 1603 and subsequent steps. In a case where there is no entry including the variable var (NO in Step 1606), the CPU 321 performs processing after Step 1608.

In a case where the position of the instruction to be executed has reached the end position of the tuning target portion (YES in Step 1603), the CPU 321 invalidates the cache monitor mode by transmitting an invalidation signal to the L2 cache 324 (Step 1609). Then, the CPU 321 checks whether or not to continue the processing (Step 1610).

In a case where the processing is continued (YES in Step 1610), the CPU 321 repeats the processing of Step 1601 and subsequent steps. In a case where the processing is not continued (NO in Step 1610), the CPU 321 ends the execution of the debugger 1402 and the analysis target program.

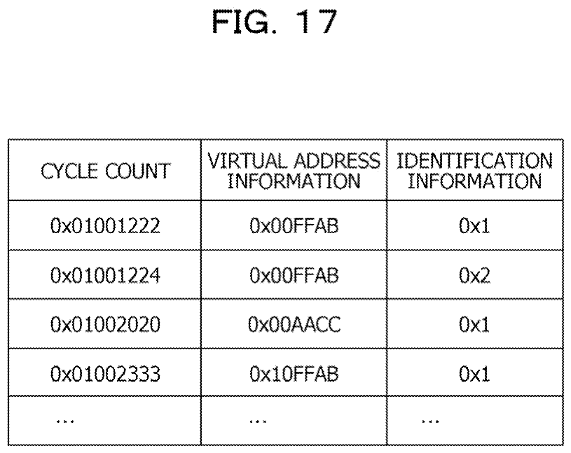

FIG. 17 illustrates an example of the log information 422 acquired in the processing 1434 in the log acquisition mode of FIG. 14. Each entry of the log information 422 of FIG. 17 includes a cycle count, virtual address information, and identification information.

Identification information “0x1” associated with a virtual address

“0x00FFAB” of a cycle count “0x01001222” indicates fetch (L2→L1). Identification information “0x2” associated with a virtual address “0x00FFAB” of a cycle count “0x01001224” indicates fetch (main→L2).

The identification information “0x1” is also associated with a virtual address “0x00AACC” of a cycle count “0x01002020” and a virtual address “0x10FFAB” of a cycle count “0x01002333”.

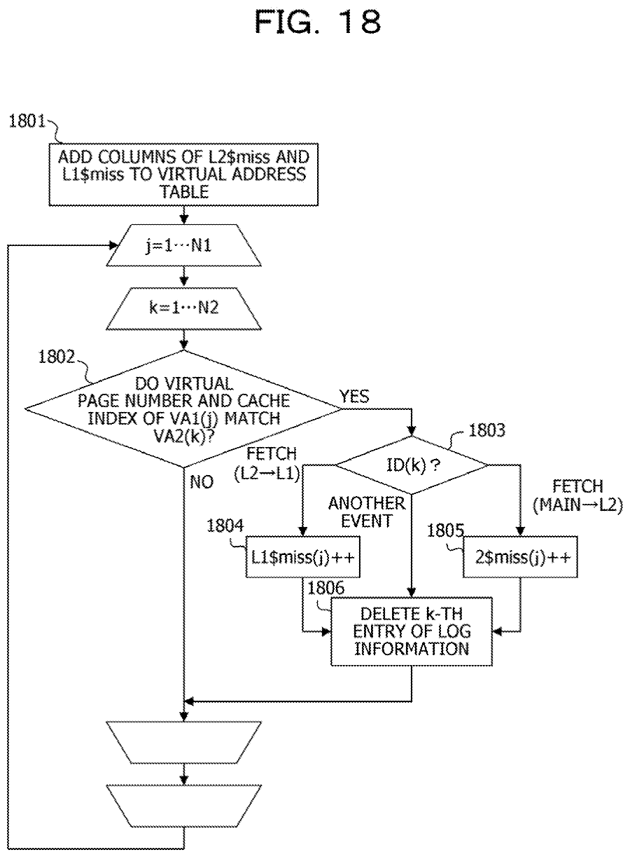

FIG. 18 is a flowchart illustrating an example of the log information analysis processing performed in the procedure 1421 of FIG. 14. The CPU 321 performs the log information analysis processing of FIG. 18 by executing the debugger 1402.

First, the CPU 321 adds columns of L2$miss and L1$miss to the virtual address table, and sets L2$miss and L1$miss of each entry to 0 (Step 1801). L1$miss represents the number of times a cache miss has occurred in the L1 cache 323, and L2$miss represents the number of times a cache miss has occurred in the L2 cache 324.

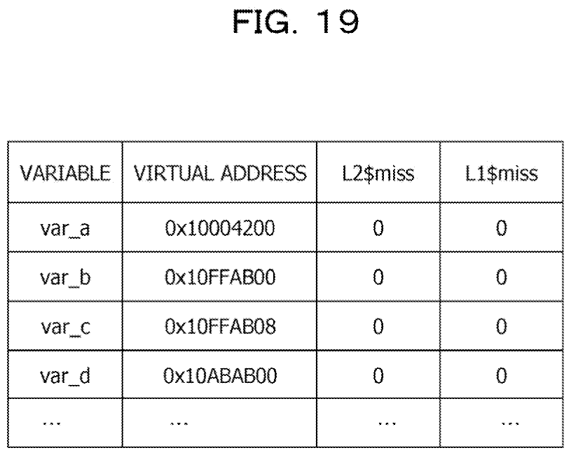

FIG. 19 illustrates an example of the virtual address table to which the columns of L2$miss and L1$miss are added. In the virtual address table of FIG. 19, L2$miss and L1$miss of each entry are 0.

Next, the CPU 321 performs processing of Step 1802 to Step 1806 by using a control variable j (j=1 to N1) indicating an entry of the virtual address table and a control variable k (k=1 to N2) indicating an entry of the acquired log information 422. N1 represents the number of entries of the virtual address table, and N2 represents the number of entries of the log information 422.

In the following description, VA1(j) represents a virtual address of a j-th entry of the virtual address table. L1$miss(j) represents L1$miss in the j-th entry of the virtual address table, and L2$miss(j) represents L2$miss in the j-th entry of the virtual address table.

VA2(k) represents virtual address information of a k-th entry of the log information 422, and ID(k) represents identification information of the k-th entry of the log information 422.

First, the CPU 321 sets j to 1 and k to 1 to compare a virtual page number and cache index of VA1(j) with VA2(k) (Step 1802). In a case where the virtual page number and cache index of VA1(j) match VA2(k) (YES in Step 1802), the CPU 321 checks ID(k) (Step 1803).

In a case where ID(k) indicates fetch (L2→L1), the CPU 321 increments L1$miss(j) by 1 (Step 1804), and deletes the k-th entry of the log information 422 (Step 1806). With this configuration, the number of times the fetch (L2→L1) of data indicated by the j-th virtual address occurs is counted as the number of times a cache miss occurs in the L1 cache 323.

In a case where ID(k) indicates fetch (main L2), the CPU 321 increments L2$miss(j) by 1 (Step 1805), and deletes the k-th entry of the log information 422 (Step 1806). With this configuration, the number of times the fetch (main L2) of data indicated by the j-th virtual address occurs is counted as the number of times a cache miss occurs in the L2 cache 324.

In a case where ID(k) indicates an event other than the fetch (L2→L1) and the fetch (main L2), the CPU 321 deletes the k-th entry of the log information 422 (Step 1806).

Next, the CPU 321 increments k by 1. Then, in a case where k after the increment is N2 or less, the CPU 321 repeats the processing of Step 1802 and subsequent steps.

In a case where the virtual page number and cache index of VA1(j) do not match VA2(k) (NO in Step 1802), the CPU 321 increments k by 1. Then, in a case where k after the increment is N2 or less, the CPU 321 repeats the processing of Step 1802 and subsequent steps.

In a case where k after the increment is greater than N2, the CPU 321 sets k to 1, and increments j by 1. Then, in a case where j after the increment is N1 or less, the CPU 321 repeats the processing of Step 1802 and subsequent steps.

In a case where the k-th entry of the log information 422 is deleted in Step 1802, it is determined that the virtual page number and cache index of VA1(j) do not match VA2(k). In a case where j after the increment is greater than N1, the CPU 321 ends the processing.

According to the log information analysis processing of FIG. 18, for the tuning target portion in the analysis target program, each virtual address recorded in the log information 422 is associated with the variable recorded in the virtual address table. With this configuration, in each of the L1 cache 323 and the L2 cache 324, the number of times a cache miss has occurred for data indicated by each variable may be acquired.

Thereafter, in the procedure 1422 of FIG. 14, the CPU 321 specifies a cause of the cache miss. First, the CPU 321 extracts a variable X in which a cache miss has occurred a predetermined number of times or more from the virtual address table including L2$miss and L1$miss, and specifies a position of the variable X in the analysis target program.

Next, the CPU 321 extracts an entry including virtual address information of the variable X, which is recorded before the fetch (L2→L1) or the fetch (main→L2) in the log information 422 acquired in the processing 1434 in the log acquisition mode. Then, the CPU 321 specifies a prefetch failure, replacement or invalidation of a cache line, or the like as the cause of the cache miss from an event indicated by identification information included in the extracted entry.

The CPU 321 displays the position of the variable X in the analysis target program and the specified cause of the cache miss on the screen of the display device 314 as an analysis result. The CPU 321 may further display the virtual address table including L2$miss and L1$miss on the screen.

The user 1401 performs tuning of the analysis target program on the basis of the displayed analysis result. For example, in a case where the cause of the cache miss is replacement of a cache line, expulsion prevention measures such as software prefetch are taken. Furthermore, in a case where the cause of the cache miss is invalidation of a cache line, parallel computing algorithm or a shared memory use method is reviewed, and in a case where the cause of the cache miss is a hardware prefetch failure, software prefetch is inserted.

By performing such tuning, the number of times a cache miss occurs for the variable X may be efficiently reduced. Instead of the user 1401, a compiler may perform tuning of the analysis target program.

Note that, in the information processing apparatus 301 of FIG. 3, the L1 cache 323 and the L2 cache 324 may also store instructions instead of data. In this case, a packet transmitted and received between the L1 cache 323 and the L2 cache 324, or between the L2 cache 324 and the memory unit 312 includes event information, a target instruction to be a target of an event, and a physical address of the target instruction. Then, the analysis processing of FIG. 14 is performed in a similar manner to a case where the target of the event is data.

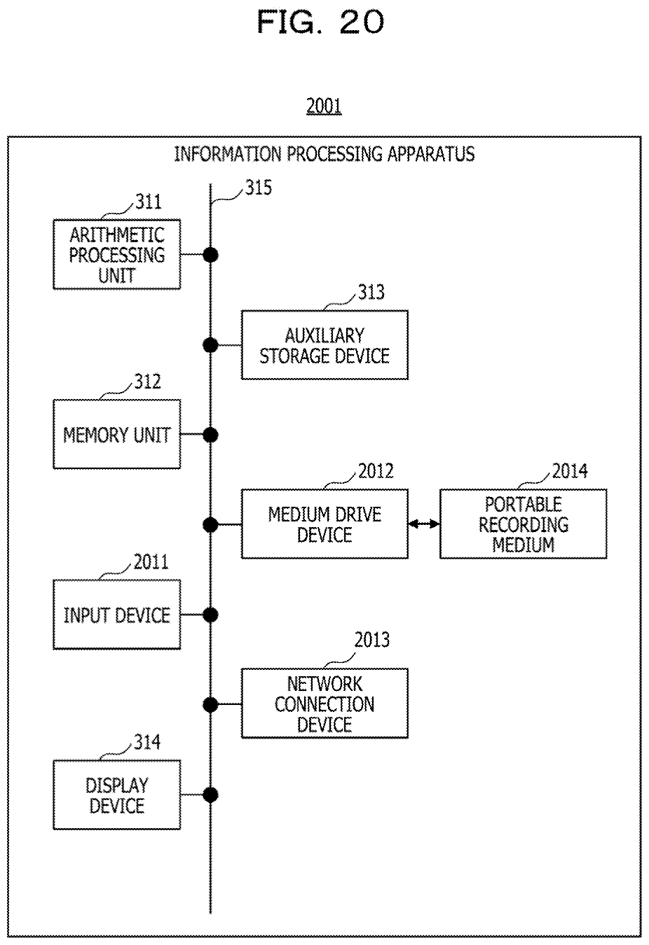

FIG. 20 illustrates a second hardware configuration example of the information processing apparatus 101 of FIG. 1. An information processing apparatus 2001 of FIG. 20 has a configuration in which an input device 2011, a medium drive device 2012, and a network connection device 2013 are added to the information processing apparatus 301 of FIG. 3. These components are hardware, and are connected to each other by a bus 315.

The input device 2011 is, for example, a keyboard, a pointing device, or the like, and is used for inputting an instruction or information from a user.

The medium drive device 2012 drives a portable recording medium 2014, and accesses contents recorded in the portable recording medium 2014. The portable recording medium 2014 is a memory device, a flexible disk, an optical disk, a magneto-optical disk, or the like. The portable recording medium 2014 may be a compact disk read only memory (CD-ROM), a digital versatile disk (DVD), a universal serial bus (USB) memory, or the like.

The user may store a program and data used for processing in the portable recording medium 2014, and load the program and data into the memory unit 312 for use. Examples of the program used for processing include the analysis target program and the debugger 1402. The information processing apparatus 2001 may store the program and data used for processing in the auxiliary storage device 313, and load the program and data into the memory unit 312 for use.

As described above, a computer-readable recording medium in which the program and data used for processing are stored is a physical (non-transitory) recording medium such as the memory unit 312, the auxiliary storage device 313, or the portable recording medium 2014.

The network connection device 2013 is a communication interface circuit that is connected to a communication network such as a local area network (LAN) and a wide area network (WAN), and that performs data conversion pertaining to communication. The information processing apparatus 2001 may receive a program and data used for processing from an external device via the network connection device 2013, and load the program and data into the memory unit 312 for use.

The configurations of the information processing apparatus 101 of FIG. 1, the information processing apparatus 301 of FIG. 3, and the information processing apparatus 2001 of FIG. 20 are merely examples, and some components may be omitted or changed according to use or conditions of the information processing apparatus.

The configuration of the L2 cache 324 of FIG. 4 is merely an example, and some components may be omitted or changed according to use or conditions of the information processing apparatus 301. The configuration of the table control unit 411 of FIG. 8 is merely an example, and some components may be omitted or changed according to use or conditions of the information processing apparatus 301. The configuration of the log control unit 412 of FIG. 10 is merely an example, and some components may be omitted or changed according to use or conditions of the information processing apparatus 301.

The flowcharts of FIGS. 2, 16, and 18 are merely examples, and some of the processing may be omitted or changed according to the configuration or conditions of the information processing apparatus 301. The operation of the information processing apparatus 301 of FIGS. 11 and 12 and the processing of FIGS. 13 and 14 are merely examples, and some procedures may be omitted or changed according to the configuration or conditions of the information processing apparatus 301.

The conversion table 421 illustrated in FIG. 5 is merely an example, and the conversion table 421 changes according to the analysis target program. The virtual address and physical address illustrated in FIG. 6 are merely examples, and the virtual address and the physical address change according to the configuration or conditions of the information processing apparatus 301. The log information 422 illustrated in FIGS. 7 and 17 is merely an example, and the log information 422 changes according to the analysis target program.

The update information illustrated in FIG. 9 is merely an example, and a format of the update information changes according to a format of the conversion table 421. The virtual address tables illustrated in FIGS. 15 and 19 are merely examples, and the virtual address table changes according to the analysis target program.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
an arithmetic processing unit that includes: a processor that executes a program; and a cache memory coupled to the processor,
wherein the cache memory includes:
an acquisition unit that acquires a physical address of target information that is a target of an event that has occurred in the cache memory when the program is executed; and
a generation unit that converts the physical address of the target information into a virtual address of the target information by using correspondence information that indicates correspondence between the physical address of the target information and the virtual address of the target information, and generates log information in which virtual address information that indicates the virtual address of the target information and identification information of the event are associated with each other.

2. The information processing apparatus according to claim 1, further comprising a memory unit,
wherein the event is a reception operation in which the cache memory receives the target information, the physical address of the target information, and event information that indicates the event from the memory unit when a cache miss for the target information occurs in the cache memory,
the acquisition unit acquires the physical address of the target information and the event information received by the cache memory, and
the generation unit generates the identification information of the event on the basis of the event information.

3. The information processing apparatus according to claim 2, wherein
the arithmetic processing unit further includes a first cache memory, and
the cache memory in which the event has occurred is a second cache memory that belongs to a memory hierarchy lower than the first cache memory.

4. The information processing apparatus according to claim 1, wherein
the arithmetic processing unit further includes a first cache memory,
the cache memory in which the event has occurred is a second cache memory that belongs to a memory hierarchy lower than the first cache memory,
the event is a transmission operation in which the second cache memory transmits the target information, the physical address of the target information, and event information that indicates the event to the first cache memory when a cache miss for the target information occurs in the first cache memory,
the acquisition unit acquires the physical address of the target information and the event information transmitted by the second cache memory, and
the generation unit generates the identification information of the event on the basis of the event information.

5. The information processing apparatus according to claim 3, wherein
the arithmetic processing unit further includes a conversion unit that holds the correspondence information,
the conversion unit receives the virtual address of the target information from the processor, and converts, by using the held correspondence information, the received virtual address of the target information into the physical address of the target information, and
the second cache memory further includes:
a storage unit that stores the correspondence information; and
an update unit that updates the correspondence information stored in the storage unit of the second cache memory on the basis of update information that indicates update of the correspondence information held by the conversion unit.

6. An information processing method by an arithmetic processing unit,
the information processing method comprising:
executing a program;
acquiring a physical address of target information that is a target of an event that has occurred in a cache memory when the program is executed;
converting the physical address of the target information into a virtual address of the target information by using correspondence information that indicates correspondence between the physical address of the target information and the virtual address of the target information; and
generating log information in which virtual address information that indicates the virtual address of the target information and identification information of the event are associated with each other.
